(19) United States
(12) Patent Application Publication
(10) Pub. No.: US 2020/0173155 A1
(43) Pub. Date: Jun. 4, 2020

(54) SINK MOUNTING CLAMP

(71) Applicant: Franke Kindred Canada Limited, Midland (CA)

(72) Inventor: Colin WISNIEWSKI, Port Elgin (CA)

(21) Appl. No.: 16/594,910

(22) Filed: Oct. 7, 2019

Related U.S. Application Data
(60) Provisional application No. 62/774,086, filed on Nov. 30, 2018.

(51) Int. Cl. E03C 1/33

(52) U.S. Cl. CPC E03C 1/335; F16B 2/065

(57) ABSTRACT

A sink clip useful for mounting a drop in sink has a clip body and a coupling that includes a hook for attaching the clip body to a sink. The coupling may be designed to attach to a rail of the sink. A clamp is movable relative to the clip body. The clamp is operable to clamp against an underside of a countertop in which the sink is to be installed. A foot or back support is slidably mounted to the clip body such that the foot can be advanced from a retracted position to a deployed position. A lock prevents the foot from being returned from the deployed position toward the retracted position. The foot can resist deflection of the clip resulting from forces exerted by the clamp.

### CROSS-REFERENCE TO RELATED APPLICATION

This application claims the benefit under 35 U.S.C. § 119 of U.S. Application No. 62/774,086 filed 30 Nov. 2018 and entitled SINK MOUNTING CLAMP which is hereby incorporated herein by reference for all purposes.

### FIELD

The present invention relates to clamps for attaching sink basins into countertops. The invention has particular application to mounting drop in sink basins equipped with mounting rails.

### BACKGROUND

A drop in sink basin (or ‘sink’) is typically installed by lowering the sink into an appropriately-sized aperture in a countertop. An upper surface of the sink or ledge extends to cover the opening and to support the weight of the sink on the countertop. The sink is then fastened in place using clips which attach to the underside of the sink and clamp against a bottom surface of the countertop.

Some sinks provide downwardly-projecting tabs or rails that include apertures for attaching clips to the sink. Tabs or rails on different sinks may project from the sink by different distances. The tabs must be inset far enough from the edge of the sink ledge to allow the sink to fit into the countertop aperture.

There is a need for new ways to install sinks that are easy, quick and secure.

### SUMMARY

This application has a number of aspects. These include, without limitation: clips useful for mounting drop in sinks. Couplings useful for attaching sink clips to sink rails. Methods for mounting drop in sinks and methods for affixing sink clips to sink rails.

One example aspect of the invention provides a sink clip useful for mounting a drop in sink has a clip body and a coupling that includes a hook for attaching the clip body to a sink. The coupling may be designed to attach to a rail of the sink. A clamp is movable relative to the clip body. The clamp is operable to clamp against an underside of a countertop in which the sink is to be installed. A foot or back support is slidably mounted to the clip body such that the foot can be advanced from a retracted position to a deployed position. A lock prevents the foot from being returned from the deployed position toward the retracted position. The foot can resist deflection of the clip resulting from forces exerted by the clamp.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a perspective view of a prior art sink rail.

FIG. 2 is a perspective view of a prior art clip that may be connected to a rail and used to hold a drop in sink in place.

FIG. 2A is a schematic illustration showing forces applied to a sink clip in use.

FIG. 3 is a schematic illustration showing a sink clip according to an example embodiment.

FIG. 4 is an exploded view of a sink clip according to an example embodiment of the invention.

FIG. 4A is a perspective view of a rail lock according to an example embodiment of the invention.

FIG. 4B is a side elevation view of the rail lock shown in FIG. 4A.

FIG. 4C is a perspective view of the rail lock shown in FIG. 4A mounted to a sink rail.

FIG. 4D is a magnified partial cross sectional view of the coupling portion of the clip body shown in FIG. 4

FIG. 4E is a rear elevation view of the clip body shown in FIG. 4.

FIG. 4F is a magnified top view of the clip foot shown in FIG. 4.

FIG. 4G is a cross section on the line 4G-4G of the clip foot shown in FIG. 4F.

FIG. 5A illustrates a step of connecting a sink clip to a rail on which a rail lock is mounted.

FIG. 5B is a perspective partially cut-away view of a clip of the type shown in FIG. 4 mounted to a sink rail by way of a rail lock of the type shown in FIG. 4A.

FIGS. 5C, 5D, 5E and 5F illustrate steps in operating a sink clip of the type shown in FIG. 4 to clamp against a countertop.

FIG. 6 is a perspective view showing a sink clip of the type shown in FIG. 4 in an installed configuration.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

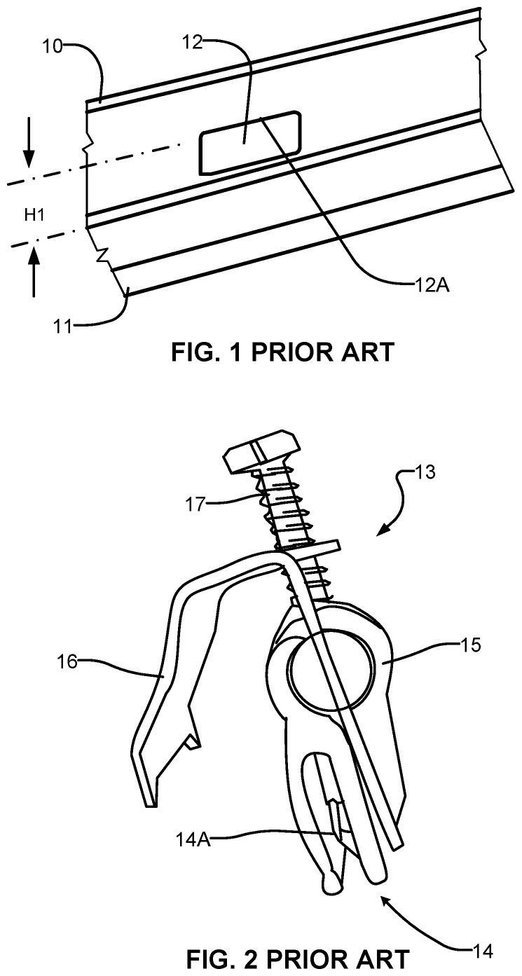

FIG. 1 shows a rail 10 of the type that may be provided to support clips for mounting a drop-in style sink. Rail 10 projects from the underside of a ledge 11 that, when the sink is installed will lie against the top surface of a countertop. A slot 12 is provided in rail 10 for attachment of a sink clip. Various designs of sink clip capable of attaching to rail 10 using slot 12 are commercially available. Such clips typically include a hook that projects through slot 12 to engage an edge 12A of slot 12. The distance H1 between ledge 11 and slot edge 12A may be different for different sinks.

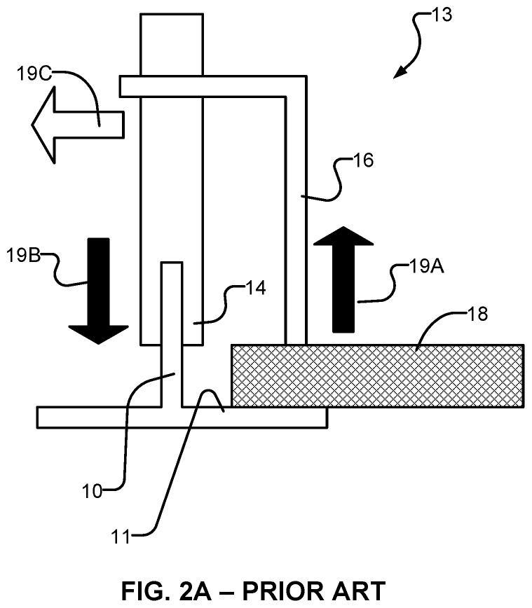

FIG. 2 shows an example prior art clip 13. Clip 13 includes a coupling 14 for engaging slot 12. Coupling 14 includes a hook 14A. A clamp 16 is movable relative to a body 15 of clamp 13 by turning a screw 17.

FIG. 2A is a schematic diagram illustrating forces that act on a clip of the general type exemplified by clip 13 when the clip is tightened to clamp a sink to a countertop 18. A reaction force 19A is exerted by the countertop on clamp 16. A reaction force 19B directed oppositely to reaction force 19A is exerted by rail 10 on coupling 14. Because forces 19A and 19B are not aligned with one another their couple exerts a torque on clip 13. Since coupling 14 is attached to rail 10 the resulting torque tends to deflect the end of clip 10 in the direction of arrow 19C. In some cases the deflection is enough to cause coupling 14 to detach from rail 10.

This invention provides improved sink clips. Embodiments of the invention incorporate one or both of a movable foot which helps to counteract the deflection described above and an improved coupling for anchoring a sink clip to a rail.

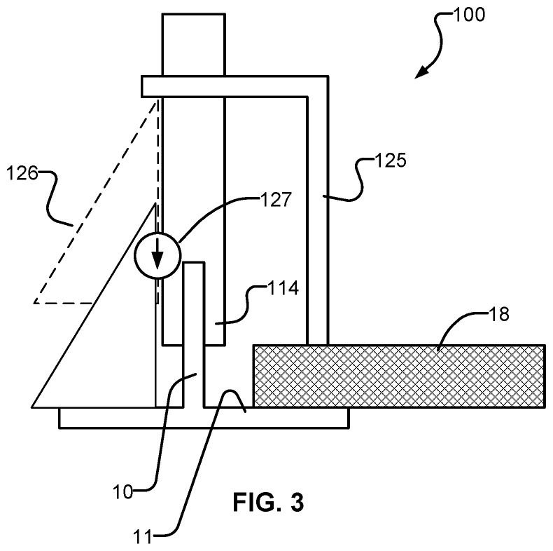

FIG. 3 illustrates an improved sink clip 100 according to an example embodiment. Clip 100 comprises a coupling 114 for coupling clip 100 to a rail 10 and a clamp 125 operable to be clamped against the bottom surface of a countertop 18. Any suitable mechanism may be provided to perform the function of advancing clamp 125 to grip countertop 18. By way of non-limiting example the mechanism for advancing clamp 125 may be like that described in U.S. Pat. No. 9,382,702 which is hereby incorporated herein by reference for all purposes. Any suitable mechanism may be provided to perform the function of coupling clip 100 to rail 10. By way of non-limiting example, coupling 114 may have a structure similar to coupling 14 shown in FIG. 2.

Clip 100 additionally includes a movable foot 126 (which may also be called a back support). Foot 126 may be advanced from a retracted position (shown in dotted lines) to a deployed position (shown in solid lines) in which foot 126 engages ledge 10. Foot 126 is located on a side of sink clip 100 that is away from countertop 18. A lock is provided to retain foot 126 in its deployed position. The engagement of foot 126 on ledge 11 held by lock 127 counteracts the tendency of clip 100 to be deflected away from countertop 18 as clamp 125 is tightened.

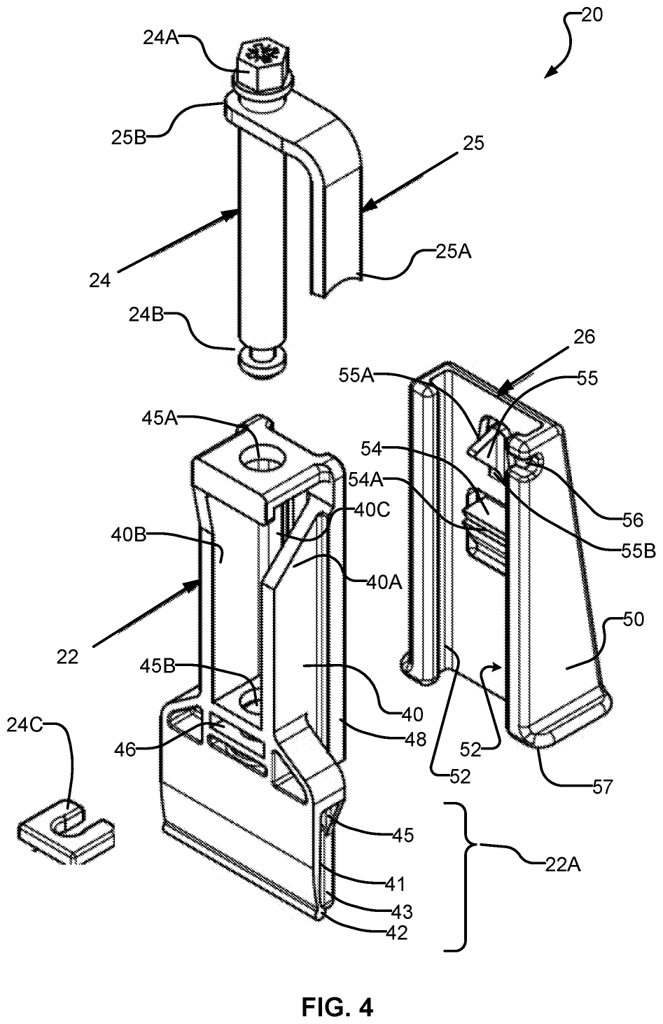

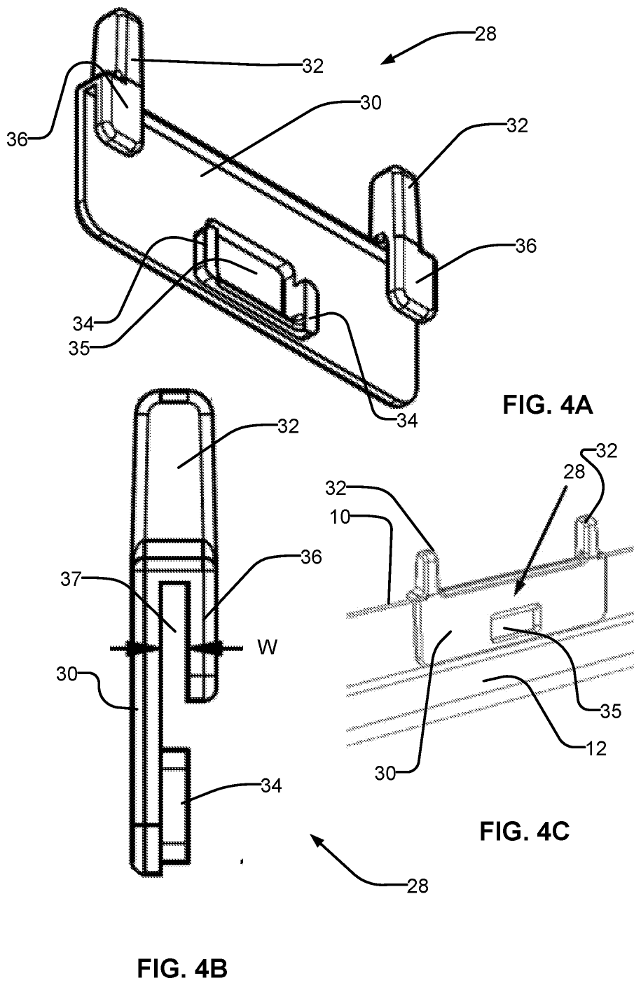

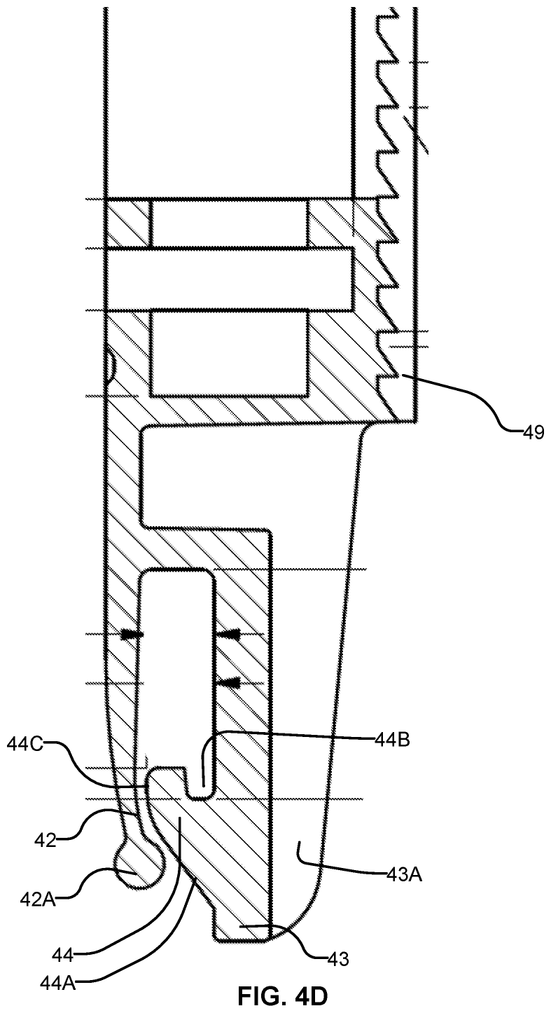

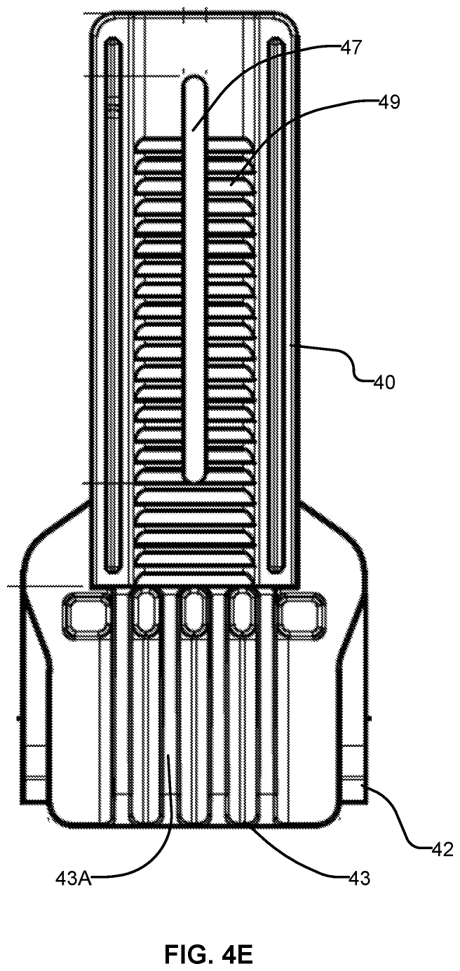

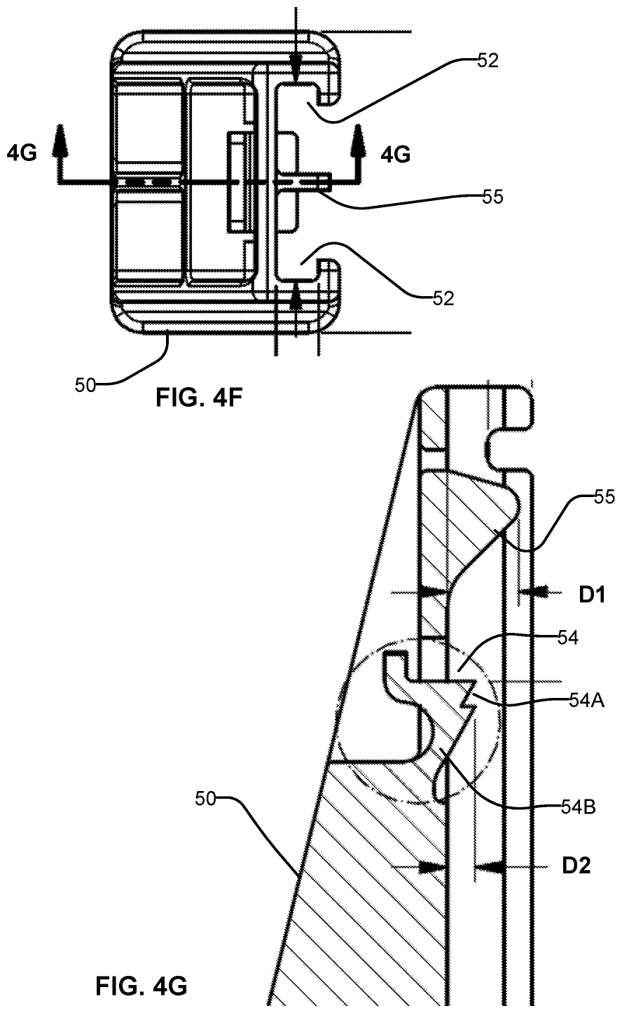

Clip 100 may be designed to allow foot 126 to be moved into contact with a ledge of a sink in any of a wide variety of ways including: pushing by hand or with a tool, a cam, impact with a tool, a screw connected to advance foot 126 relative to the main body of clip 100 or the like. In preferred embodiments the same mechanism provided to operate clamp 125 may be configured to also advance foot 126. A non-limiting example of such a mechanism is described below and shown in FIGS. 4 to 4G. Lock 127 may, for example, comprise a ratchet mechanism.

FIGS. 4 and 4A to 4G illustrate features of construction of a clip 20 according to a more detailed example embodiment which implements the principle of operation illustrated by clip 100 of FIG. 3. Clip 20 is assembled from a main part 22 which includes a coupling 22A, a clamp 25 actuated by a screw 24, and a foot 26. A rail lock 28 (see FIGS. 4A to 4C) may be used in conjunction with clip 20. The assembled clip 20 may be affixed to a sink rail as described below.

Main part 22 comprises a body 40 having coupling 22A formed at one end thereof. Coupling 22A comprises arms 42 and 43 which are separated by a gap 41 into which a rail 10 (not shown in FIG. 4) can be received. A hook 44 provided on arm 43 is dimensioned to engage a slot 12 in a tab 10. Engagement of hook 44 into a slot 12 can couple main part 22 to a tab 10. A lower end 44A of hook 44 is tapered to assist in spreading arms 42 and 43 as coupling 22A is forced into place on a rail 10.

The bodies of main part 22 and foot 26 may be formed from a suitable material. An example of a suitable material is a plastic such as an acetal plastic of which Delrin™ is an example.

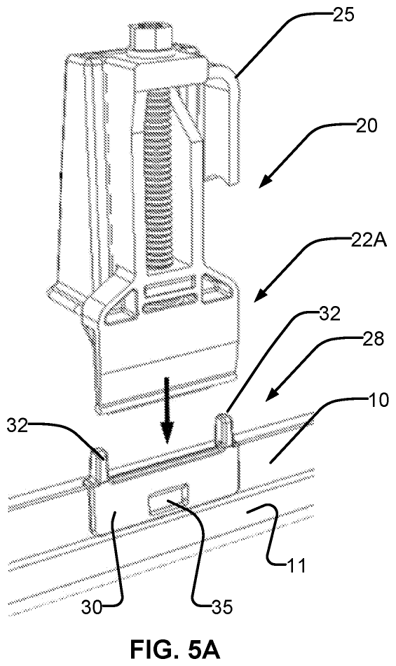

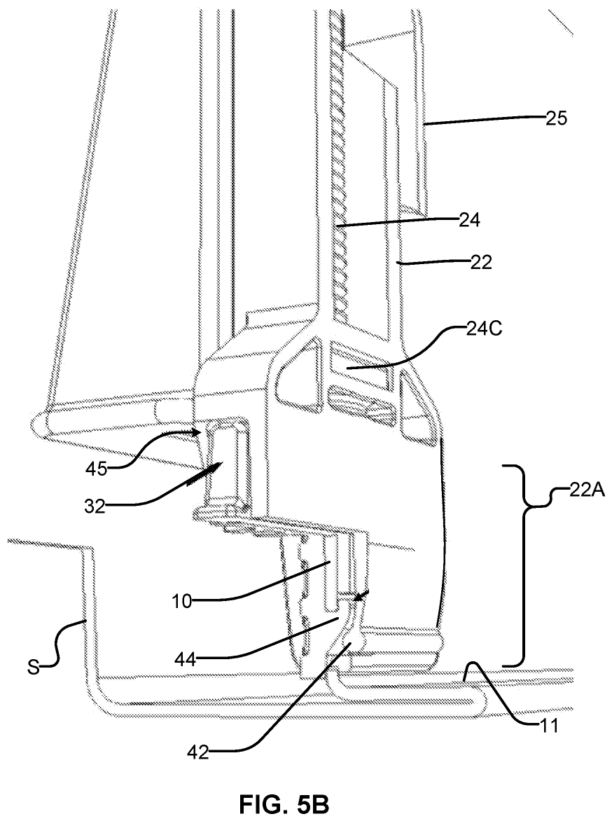

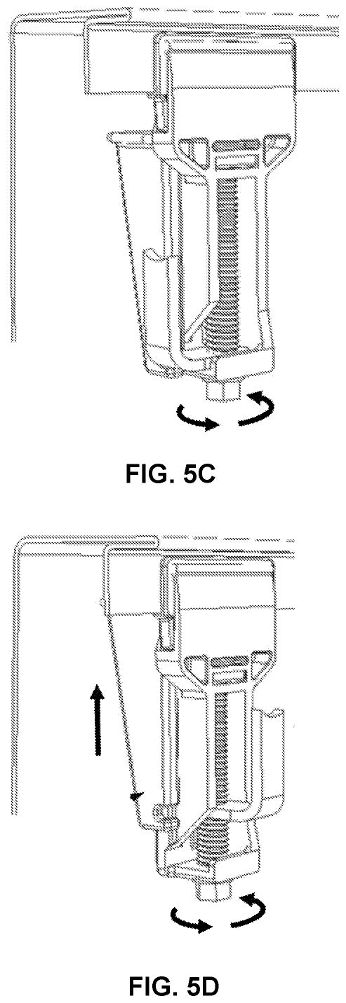

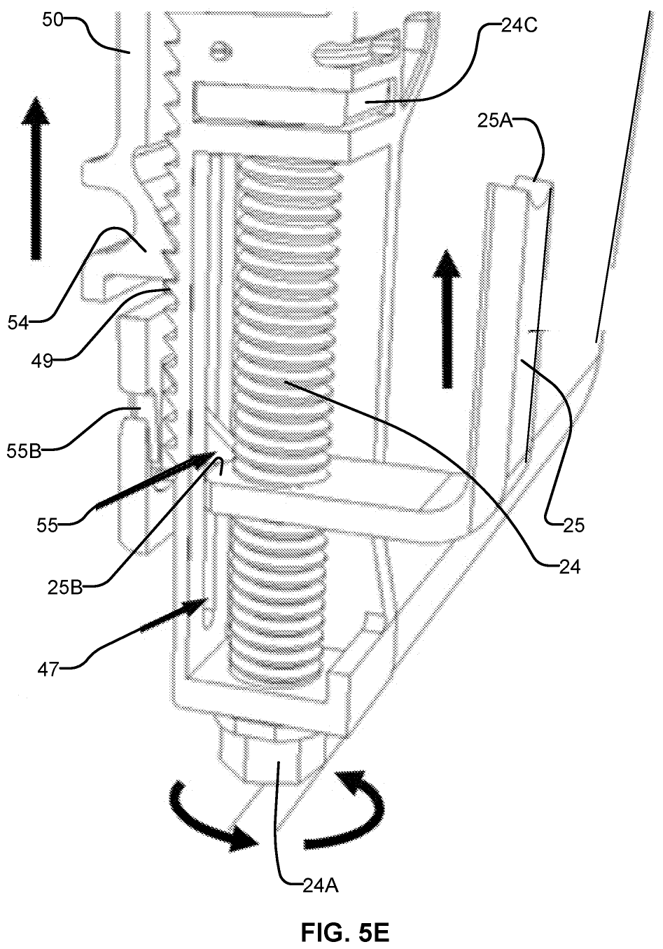

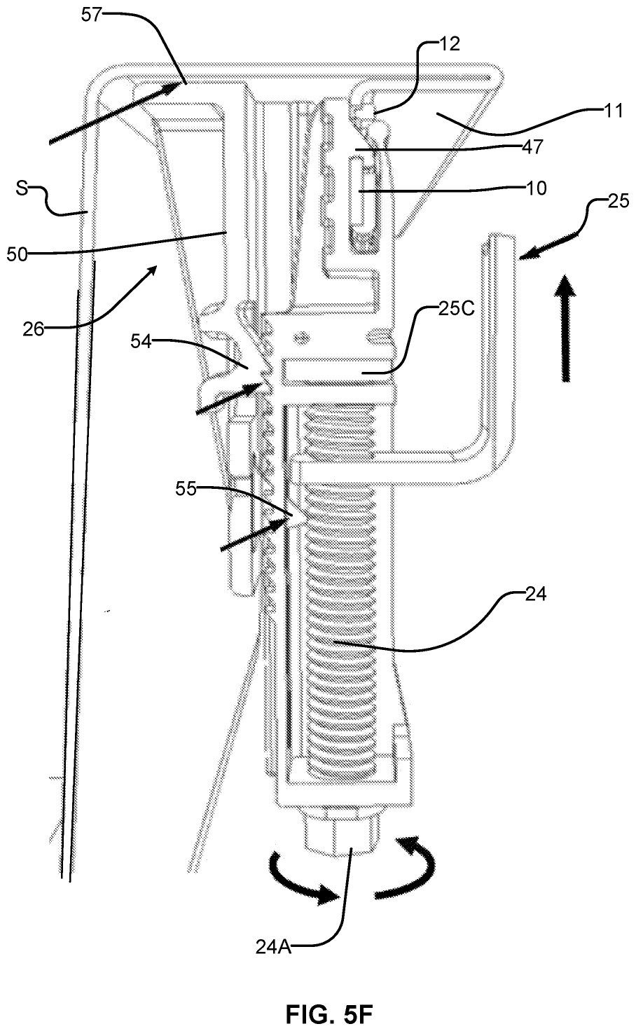

In the illustrated embodiment, coupling 22A is assisted by a rail lock 28 as shown in FIGS. 4A to 4C. Rail lock 28 is designed to couple to a rail 10. Main part 22 can then be locked to the rail 10 over rail lock 28 as illustrated in FIG. 5A. The illustrated coupling which includes the rail lock 28 can provide increased holding force without making it excessively hard to engage main part 22 to rail 10 and also facilitates installation by helping to maintain alignment between main part 22 and a slot 12 to which main part 22 is to be coupled.

Rail lock 30 is configured to clip on over the outer edge of a rail 10. Rail lock 28 comprises a body 30. Body 30 can be generally planar and fits against a face of rail 10. Tabs 34 project from body 30 and are located to project into a slot 12 in rail 10. An aperture 35 located between tabs 34 is dimensioned to receive hook 44. Fingers 36 are located along one edge of body 30 which is spaced apart from tabs 34. Rail lock 28 can be placed over a rail 10 so that tabs 34 project into a slot 12 and fingers 36 are hooked over the outer edge of tab 10 (see FIG. 4C).

Rail lock 28 may be formed from a suitable material. An example of a suitable material is a plastic such as nylon.

Posts 32 project from body 30 in a direction that is parallel to the face of body 30. When tabs 34 are engaged in a slot 12, posts 32 have a known alignment to the slot 12. Posts 32 are spaced apart from one another by a distance large enough to receive coupling 22A between them. Posts 32 help to align coupling 22A with slot 12 as clip 20 is snapped into place (see FIG. 5A). Preferably coupling 22A is dimensioned to slide between posts 32 and when coupling 22A is located between posts 22, hook 44 is aligned with aperture 35 in rail clip 28 and with slot 12 in rail 10. In the illustrated embodiment, coupling 22A includes pockets 45 into which tops of posts 32 project when coupling 22A is coupled to a rail 10 (see FIGS. 4 and 5B).

As coupling 22A is pushed into place on a rail 10 arms 42 and 43 are forced apart to allow hook 44 to pass by the outer edge of rail 10. When hook 44 is aligned with apertures 12 and 35, hook 44 is pulled into place in apertures 12 and 35 by the resiliency of arm 42. Groove 44B is then aligned with rail 10 such that, when a countertop is clamped, as described below, groove 44B receives an edge of slot 12. In the illustrated embodiment, when arm 42 is in its neutral position, as shown in FIG. 4D, the end 42A of arm 42 is closer to arm 43 than the outer side 44C of hook 44.

Advantageously, arm 43 which carries hook 44 is stiffer than arm 42. In the illustrated embodiment, arm 43 includes buttresses 43A which stiffen it.

The illustrated coupling 22A is but one of many options for coupling clip 20 to a rail 10. Some embodiments provide alternative structures for coupling 22A.

In the illustrated embodiment, clamp 25 is actuated by screw 24. Screw 24 is received in holes 45A and 45B and retained by a clip 24C which engages a groove 24B in screw 24. Clip 24C is received in notch 46 in main body 22. This construction allows screw 24 to rotate but holds screw 24 against axial movement relative to body 40. Clamp 25 is threadedly engaged with threads of screw 24 such that when screw 24 is turned (e.g. by turning head 24A) clamp 25 moves along screw 24.

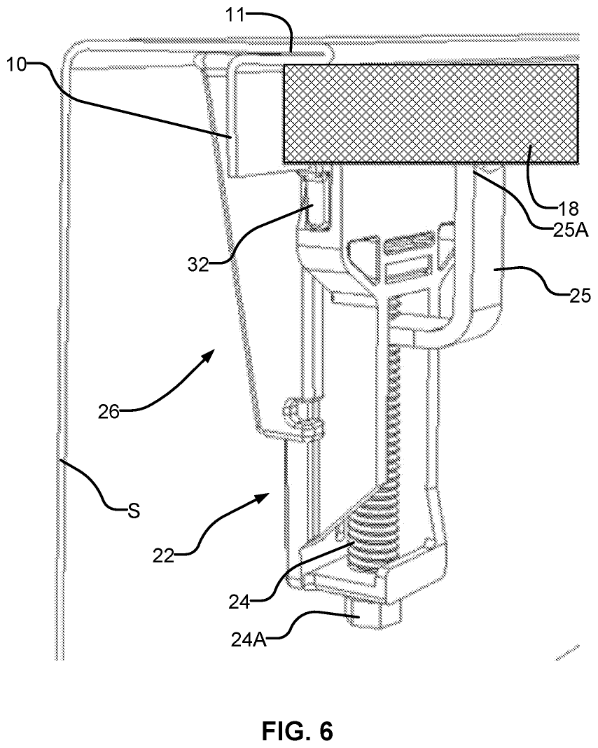

Clamp 25 can be advanced by turning screw 24A until the tip 25A of clamp 25 engages a countertop (see e.g. FIG. 6) with a desired level of force to hold a sink in place. Walls 40A and 40B guide clamp 25 and prevent clamp 25 from turning.

Advantageously, clamp 25 is initially oriented generally parallel to a sink rail 10 (see e.g. FIGS. 5A to 5C). Rotation of head 24A of screw 24 initially turns clamp through approximately 90 degrees so that clamp 25 is at least roughly perpendicular to the rail 10. Further rotation of screw 24 advances clamp 25 along screw 24. To facilitate this mode of operation, a cutout 40C is provided in wall 40A. A slot 46 is provided in the body of foot 26. Clamp 25 may initially be oriented to extend through cutout 40C and slot 46. Extending clamp 25 through slot 46 helps to prevent foot 26 from moving longitudinally relative to main body 22 until after a user starts to advance clamp 26.

When screw 24 is turned, clamp 25 initially rotates together with screw 24 until clamp 25 hits wall 40B. Further rotation of screw 24 advances clamp 25 toward coupling 22A.

Foot 26 is slidingly engaged with main body 22. In the illustrated embodiment this is achieved by providing flanges 48 extending along either side of body 40 which are received in opposing grooves 52 provided on body 50.

A locking mechanism is provided in the illustrated embodiment by a ratchet. Body 40 carries teeth 49 which are engaged by teeth 54A on a resiliently-mounted pawl 54. This mechanism allows foot 26 to be advanced toward a ledge 11 and subsequently prevents foot 26 from being retracted. Foot 26 may be advanced by different distances depending upon the dimensions of a rail on which clip 20 is mounted.

A clip may be designed such that foot 26 is brought into engagement with ledge 11 by the advancement of clamp 25. In the illustrated embodiment this is achieved by providing a drive member on body 50 of foot 26. In the illustrated embodiment the drive member comprises a drive fin 55. Drive fin 55 projects through a slot 47 into the path of a drive portion 25B of clamp 25. Advancement of clamp 25 (which may, for example, be achieved by rotation of a screw 24 as described above) causes advancement of foot 26.

Drive fin 55 is designed to limit the amount of force that can be applied to foot 26 to less than a threshold amount. When it would require more than the threshold force to advance foot 26 (as, for example, after bottom 57 of foot 26 has contacted a ledge 11) then drive portion 25B slips past drive fin 55. Clamp 25 can then be advanced until it is desirably tight against a countertop. In the illustrated embodiment an upper surface 55A of drive fin 55 is sloped and drive fin 55 is resiliently supported. The slope is such that points on upper surface 55A that are closer to screw 24 are also closer to coupling 22A. This slope may be called a slope toward coupling 22A.

When the force applied to upper surface 55A by drive portion 25B exceeds a threshold force drive fin 55 is pushed away from screw 55 so that drive portion 25B can pass by drive fin 55. Resilient mounting of drive fin 55 is provided in the illustrated embodiment by mounting drive fin 55 on a cantilever beam 55B.

The illustrated construction allows a user to both advance foot 26 and operate clamp 25 by turning head 24B of screw 24. FIGS. 5A to 5F illustrate stages in installation of a clip 20. FIG. 5A shows installation of clip 20 to a rail 10 on which a rail lock 28 has been previously fitted. Coupling 22A is aligned between pins 32. This alignment automatically aligns hook 44 of coupling 22A with aperture 35 in rail lock 28. Clip 20 is then pressed onto rail 10 so that rail 10 is received between arms 42 and 43 of coupling 22A.

FIG. 5B shows coupling 22A after clip 20 has been attached to rail 10. Hook 10 passes through a slot in rail 10. Hook 10 is urged to project through rail 10 by the engagement of arm 42 against rail 10. The steps of FIGS. 5A and 5B may be performed while sink S is upside-down. Steps 5A and 5B may be repeated to install clips 20 at several locations around the periphery of sink S. In some cases, the steps illustrated in FIGS. 5A and 5B may be performed at a factory before the sink is shipped.

After the steps of FIGS. 5A and 5B are performed, the sink carrying clips 20 may be dropped into an aperture in a countertop. At this stage clamps 25 are oriented so that they do not interfere with lowering the sink through the cutout. The steps illustrated in FIGS. 5C to 5F may then be performed from below the sink. The countertop is not shown in FIGS. 5A to 5F for clarity.

FIG. 5C indicates that screw 24 is turned. This causes clamp 25 to rotate until it faces outwardly from the sink (see FIG. 5D). As illustrated in FIG. 5E, continued rotation of screw 24 advances clamp tip 25A toward a countertop and also advances body 50 of foot 26 toward a ledge of the sink. As foot 26 advances, teeth 54A of pawl 54 slip over teeth 49 on main body 22.

As shown in FIG. 5F, continued rotation of screw 24 after base 57 of foot 26 contacts ledge 11 advances clamp 25. In FIG. 5F clamp 25 has become uncoupled from driving foot 26 as described above.

FIG. 6 shows a final state with clip 20 bearing against the underside of a countertop 18 to hold sink S in place.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

Some features are described as being shown in the illustrated embodiment. Such features or variations of such features may optionally also be provided in other embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A sink clip useful for mounting a drop in sink, the sink clip comprising:
a clip body;
a coupling comprising a hook for attaching the clip body to a sink;
a clamp movable relative to the clip body, the clamp operable to clamp against an underside of a countertop in which the sink is to be installed;
a foot slidably mounted to the clip body such that the foot can be advanced from a retracted position to a deployed position; and,
a lock operative to prevent the foot from being returned from the deployed position toward the retracted position.

2. The sink clip according to claim 1 wherein the clamp comprises a screw mounted to rotate relative to the clip body and a drive portion that engages a drive member connected to the foot such that rotation of the screw advances the foot.

3. The sink clip according to claim 2 wherein the drive portion of the clamp is resiliently mounted relative to the drive member such that a driving association of the drive portion and the drive member is disconnected when a force between the drive portion and the drive member exceeds a threshold force.

4. The sink clip according to claim 2 wherein the screw is axially fixed relative to the clip body.

5. The sink clip according to claim 2 wherein the clamp comprises a clamp member threadedly attached to the screw wherein a first end of the clamp member provides a clamping tip for clamping against a countertop and a second end of the clamp member opposed to the first end provides the drive portion.

6. The sink clip according to claim 5 wherein the clip body comprises first and second parallel walls and a rear wall, the foot is coupled to slide along the rear wall, and the drive member projects through a slot in the rear wall of the clip body to engage the drive portion.

7. The sink clip according to claim 2 wherein a surface of the drive member against which the drive portion engages is sloped to be closer to the coupling in its parts closer to the screw.

8. The sink clip according to claim 1 wherein the lock comprises a ratchet.

9. The sink clip according to claim 8 wherein the ratchet comprises a pawl resiliently coupled to the foot, the pawl carrying one or more teeth that engage teeth supported by the clip body.

10. The sink clip according to claim 1 further comprising a rail lock, the rail lock configured to engage a slot in a rail attached to a sink and comprising a pair of spaced apart guide members that project away from an outer edge of the rail generally parallel to a plane of the rail.

11. The sink clip according to claim 10 wherein the coupling is dimensioned to fit between the guide members of the rail lock.

12. The sink clip according to claim 10 wherein the rail lock comprises a generally planar body having an aperture passing through the body and a pair of projections located on opposed sides of the aperture wherein the hook of the coupling is aligned with the aperture in the body of the rail clip when the coupling of the rail clip is aligned between the guide members of the rail lock.

13. The sink clip according to claim 10 wherein the clamp is configured to clamp the countertop on a side of the clip body opposed to the foot.

14. The sink clip according to claim 1 wherein the lock is configured to lock the foot in any one of a plurality of positions.

15. A method for clamping a drop in sink, the method comprising:
operating a sink clip attached to the sink to advance a foot that is slidably connected to a body of the sink clip toward an underside of a ledge of the sink until the foot is positioned to bear against the ledge to counteract a torque on the sink clip that arises from tightening a clamp of the sink clip; and operating the sink clip to clamp against an underside of a countertop.

16. The method according to claim 15 wherein the clip is attached to the sink by a coupling that is attached to a rail of the sink, the foot bears against the ledge on a first side of the rail and the clamp clamps against the countertop on a second side of the rail opposed to the first side of the rail.

17. The method according to claim 15 wherein operating the sink clip to advance the foot comprises turning a screw.

18. The method according to claim 17 wherein operating the sink clip to clamp the foot comprises turning the screw.

19. The method according to claim 15 wherein operating the sink clip to advance the foot comprises simultaneously advancing the clamp and advancing the foot by turning a screw.

20. The method according to claim 19 comprising decoupling the foot from being driven by the screw when the foot contacts the ledge.
